(19) United States
(12) Patent Application Publication
(10) Pub. No.: US 2011/0115947 A1
(43) Pub. Date: May 19, 2011

(54) DIGITAL PHOTOGRAPHING APPARATUS, METHOD OF CONTROLLING DIGITAL PHOTOGRAPHING APPARATUS, AND RECORDING MEDIUM FOR STORING PROGRAM TO EXECUTE METHOD OF CONTROLLING DIGITAL PHOTOGRAPHING APPARATUS

(75) Inventor: Hae-sung Oh, Seoul (KR)

(73) Assignee: Samsung Electronics Co., Ltd., Suwon-si (KR)

(21) Appl. No.: 12/948,036

(22) Filed: Nov. 17, 2010

(30) Foreign Application Priority Data
Nov. 19, 2009 (KR) 10-2009-0112186

(51) Int. Cl. H04N 5/262; H04N 5/222; G06F 3/041

(52) U.S. Cl. 348/240.99; 348/333.01; 345/173; 348/E05.051

(57) ABSTRACT

A digital photographing apparatus, a method of controlling the digital photographing apparatus, and a recording medium for storing a program to execute the method, in which a scale of an image displayed on a display unit is changed by a touch operation performed on a touchscreen, and simultaneously an optical or digital zooming operation is performed. The method of controlling the digital photographing apparatus including a touchscreen includes displaying an image on the touchscreen, recognizing a touch operation in which the image is swiped from a first point to a second point on the touchscreen, and changing an image scale so as to correspond to the recognized touch operation and displaying the image.

CROSS-REFERENCE TO RELATED PATENT APPLICATION

This application claims the benefit of Korean Patent Application No. 10-2009-0112186, filed on Nov. 19, 2009, in the Korean Intellectual Property Office, the disclosure of which is incorporated herein in its entirety by reference.

### BACKGROUND

Various embodiments of the invention relate to a digital photographing apparatus using touch recognition, a method of controlling the digital photographing apparatus, and a recording medium for storing a program to execute the method.

Due to the developments in digital photographing apparatuses, new attempts have been applied to further their development using hardware and software. For example, a touch recognition technology is used in digital photographing apparatuses to perform various operations of the digital photographing apparatuses.

However, there is a need for a technology to increase or decrease an image scale of an image displayed on a display unit through a touch input performed on a touchscreen.

### SUMMARY

An embodiment of the invention provides a digital photographing apparatus, a method of controlling the digital photographing apparatus, and a recording medium for storing a program to execute the method, in which an image scale of an image displayed on a display unit is changed through a touch input performed on a touchscreen.

An embodiment of the invention also provides a digital photographing apparatus, a method of controlling the digital photographing apparatus, and a recording medium for storing a program to execute the method, in which an image scale is changed by a touch input, and simultaneously an optical or digital zooming operation is performed.

According to an embodiment of the invention, there is provided a method of controlling a digital photographing apparatus having a touchscreen that includes displaying an image on the touchscreen; recognizing a touch operation in which the image is swiped from a first point to a second point on the touchscreen; and changing an image scale so as to correspond to the recognized touch operation and displaying the image.

The method may be performed in a photography mode, and a zooming operation may be performed so as to correspond to the changed image scale.

The touch operation in which the image is swiped from the first point to the second point may be performed by a single touch operation.

The changing of the image scale may be simultaneously performed together with the touch operation in which the image is swiped from the first point to the second point on the touchscreen.

The changing of the image scale may include increasing or decreasing of the image scale so as to correspond to a swiped length from the first point to the second point, and displaying the image.

The increasing of the image scale may be performed when the first point is positioned above the second point.

The decreasing of the image scale may be performed when the first point is positioned below the second point.

A degree of increasing or decreasing the image scale may be simultaneously displayed on the touchscreen when the image scale is increased or decreased and the image is displayed.

According to another embodiment of the invention, there is provided a non-transitory computer program product, comprising a computer usable medium having a computer readable program code embodied therein, said computer readable program code adapted to be executed to implement the method.

According to embodiment of the invention, there is provided a digital photographing apparatus including a touchscreen; a touch recognition unit for recognizing a touch operation in which the image is swiped from a first point to a second point on the touchscreen; and an image scale adjusting unit for changing an image scale so as to correspond to the recognized touch operation and displaying the image.

The digital photographing apparatus may further include a zoom controller for operating a zooming operation so as to correspond to the image scale changed in a photography mode.

The touch operation in which the image is swiped from the first point to the second point may be performed by a single touch operation.

The image scale adjusting unit may adjust the image scale simultaneously with the touch operation in which the image is swiped from the first point to the second point on the touchscreen.

The image scale adjusting unit may increase or decrease the image scale so as to correspond to a swiped length from the first point to the second point, and displays the image.

The image scale adjusting unit may display a degree of increasing or decreasing the image scale on the touchscreen simultaneously when the image scale is increased or decreased and the image is displayed.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram of a digital camera, that is, a digital photographing apparatus, according to an embodiment of the present invention;

FIGS. 2 and 3 are flowcharts of a method of controlling a digital camera, according to embodiments of the present invention;

FIGS. 4 to 6 are screen shots showing an operation of increasing an image scale so as to correspond to a touch operation, according to an embodiment of the present invention;

FIGS. 7 to 9 show an operation of decreasing the image scale so as to correspond to the touch operation, according to an embodiment of the present invention; and

FIGS. 10A and 10B are diagrams for showing a degree of increasing or decreasing an image scale by using a method of controlling a digital camera, according to an embodiment of the present invention.

### DETAILED DESCRIPTION

Hereinafter, a digital photographing apparatus, a method of controlling the digital photographing apparatus, and a recording medium storing a program to execute the method will be described with regard to exemplary embodiments of the invention with reference to the attached drawings.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the exemplary embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar references in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the present invention.

A digital camera, that is, a digital photographing apparatus, according to the present invention will be described. However, the present invention is not limited thereto, and the digital photographing apparatus may be a digital device such as a camera phone in which a digital image signal processor is installed, a personal digital assistant (PDA), a portable multimedia player (PMP), a television (TV) or a digital picture frame.

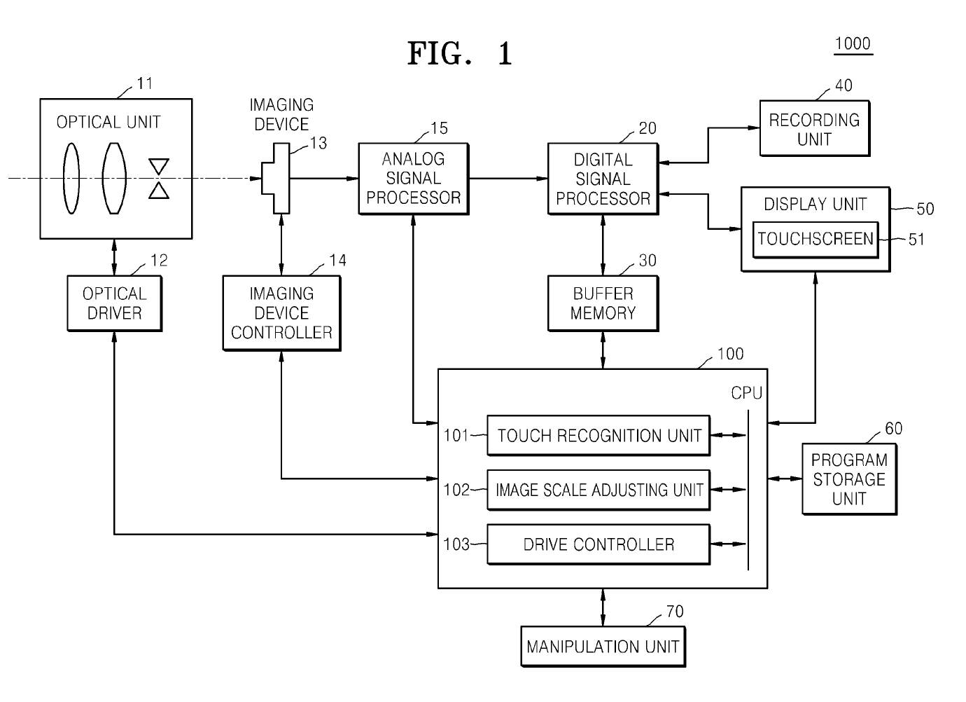

FIG. 1 is a block diagram of a digital camera 1000, that is, a digital photographing apparatus, according to an embodiment of the invention. Referring to FIG. 1, the digital camera 1000 includes an optical unit 11, an optical driver 12, an imaging device 13, an imaging device controller 14, an analog signal processor 15, a digital signal processor (DSP) 20, a buffer memory 30, a recording unit 40, a display unit 50, a program storage unit 60, a manipulation unit 70, and a central processing unit (CPU) 100.

According to the present embodiment, components of the digital camera 1000 are illustrated as individual blocks; however an aspect of the present invention is not limited thereto, and two or more components of the digital camera 1000 may be configured as a single chip. In addition, a single component for performing two or more functions may be respectively configured as two or more chips.

Each of the components of the digital camera 1000 of FIG. 1 will be described in detail below.

The optical unit 11 may include a lens for condensing the optical signal, an iris diaphragm for adjusting the amount of the optical signal (the amount of light), and a shutter for controlling inputting of the optical signal. The lens includes a zoom lens that increases or decreases a viewing angle according to a focal length. For example, if a telephoto zoom signal is input, the digital camera 1000 zooms-in and the subject appears closer to the digital camera 1000. That is, the angle of view decreases and thus it is easier to more narrowly capture the subject and the selected exposure area is increased. As another example, if a wide-angle zoom signal is input, the digital camera 1000 zooms-out and the subject appears farther from the digital camera 1000. That is, the viewing angle increases and thus it is easier to more widely capture the subject and the selected exposure area is decreased.

The optical unit 11 includes a focus lens for focusing on the subject, and other lenses. These lenses may be configured as individual lenses, or alternatively may be configured as a group of lenses. The shutter may be a mechanical shutter for controlling the incidence of light by moving the mechanical shutter. Also, instead of an additional shutter, the supply of an electrical signal to an imaging unit 13 may be controlled.

The optical driver 12 drives the optical unit 11. The optical driver 12 may adjust the position of the lens unit, open and close the iris diaphragm, and drive the shutter so as to perform automatic focusing, automatic exposure correction, iris diaphragm control, zoom changing, and focus changing. The optical driver 12 may receive a control signal for performing a zooming operation from a driver controller 103 of the CPU 100 so as to control driving of the zoom lens included in the optical unit 11.

The imaging device 13 forms an image of the subject by receiving the optical signal input by the optical unit 11. The imaging device 13 may be a complementary metal-oxide semiconductor (CMOS) sensor array, a charge-coupled device (CCD) sensor array, or other similar device. The imaging device 13 may provide image data corresponding to an image of a single frame according to a timing signal provided from the imaging device controller 14.

The analog signal processor 15 may include an analog-to-digital (A/D) converter for converting an electrical signal, that is, an analog signal supplied from the CCD sensor array, into a digital signal. Also, the analog signal processor 15 may further include a circuit for performing signal processing such as gain control or waveform shaping on the electrical signal supplied from the imaging device 13.

The DSP 20 may perform image signal processing for improving the quality of an image, such as noise reduction in input image data, Gamma correction, color filter array interpolation, color matrix correction, color correction, and color enhancement. Also, the DSP 20 may generate an image file by compressing image data that is generated during the image signal processing for improving the quality of an image, or may decompress the image data from the image file. The image data is compressed in a reversible or a non-reversible format. As an example of an appropriate format for compressing the image data, the image data can be compressed in a joint photographic experts group (JPEG) format such as JPEG 2000.

The DSP 20 may also perform unclearness processing, color processing, blur processing, edge emphasis processing, image interpretation processing, image recognition processing, image effect processing, etc. The image recognition processing may include scene recognition processing. The DSP 20 may also perform display image signal processing so as to display the operating state of the digital camera 1000 or information about an image captured by the digital camera 1000 on the display unit 50. For example, the DSP 20 may perform brightness level adjustment, color correction, contrast adjustment, contour emphasis adjustment, screen division processing, and character image generation and synthesis processing.

Image data provided from the analog signal processor 15 may be transmitted to the DSP 20 in real time. However, if a transmission speed and a calculation processing speed of the DSP 20 are different from each other, the image data may be temporally stored in the buffer memory 30, and then the image data may be transmitted to the DSP 20. The buffer memory 30 may be a memory device such as a synchronous dynamic random-access memory (SDRAM), a multi-chip package (MCP) memory, or a dynamic random-access memory (DRAM).

The image data on which a predetermined image signal processing is performed in the DSP 20 may be stored in the recording unit 40, or alternatively, may be transmitted to the display unit 50 so as to be realized as a predetermined image. The recording unit 40 may be a synchronous dynamic card (SDcard)/multi media card (MMC), a hard disk drive (HDD), an optical disk, an optical magnetic disk, a hologram memory, or other similar device.

The display unit 50 displays a predetermined image converted from the image data on which the predetermined image signal processing is performed by the DSP 20. According to the present embodiment, the display unit 50 may include a touchscreen 51 for recognizing a user's touch input. The touchscreen 51 may be further installed on a surface of a display device such as a liquid crystal display (LCD), an organic light emitting diode (OLED) display and a plasma display panel (PDP), or may be installed in the display device. In addition, the touchscreen 51 may use various methods such as a capacitance method, a resistance layer method and an optical sensing method.

The program storage unit 60 may store an operating system (OS) program and an application program that are required to operate the digital camera 1000. The program storage unit 60 may be an electrically read only memory (E2PROM), a flash memory, and a read-only memory (ROM).

The manipulation unit 70 may include components for performing settings required when a user manipulates the digital camera 1000 or photographing is performed. For example, the manipulation unit 70 may be buttons, keys, a touch panel, a touchscreen or a dial and may input a user control signal used in power on/off, photographing start/stop, playback start/stop/search, driving of an optical system, mode conversion, menu manipulation, and optional manipulation.

In addition, the digital camera 1000 may further include a communicating unit (not shown) for transmitting and receiving predetermined information to and from an external server or a terminal by using a communication method such as radio-frequency IDendification (RFID) and wireless fidelity (Wi-Fi), and a flash (not shown) for providing an amount of light for compensating for insufficient exposure and facilitating a special effect during photography.

The CPU 100 may control each component according to programs stored in the program storage unit 60, or may control each component according to a user's manipulation signal input to the manipulation unit 70, an input image, and a processed result of an image of the DSP 20. In addition, the CPU 100 may control each component so as to perform operations such as power on/off, photographing start/stop, playback start/stop/search, driving of an optical system, mode conversion, menu manipulation, and optional manipulation by recognizing a user's touch input applied to the touchscreen 51.

The CPU 100 may include a touch recognition unit 101, an image scale adjusting unit 102 and the driver controller 103.

In detail, the touch recognition unit 101 recognizes a touch operation in which an image is swiped from a first point to a second point on the touchscreen. The image scale adjusting unit 102 changes a scale of an image displayed on the touchscreen 51, and displays the image. The driver controller 103 performs a zoom operation so as to correspond to the adjusted image scale, in a photography mode.

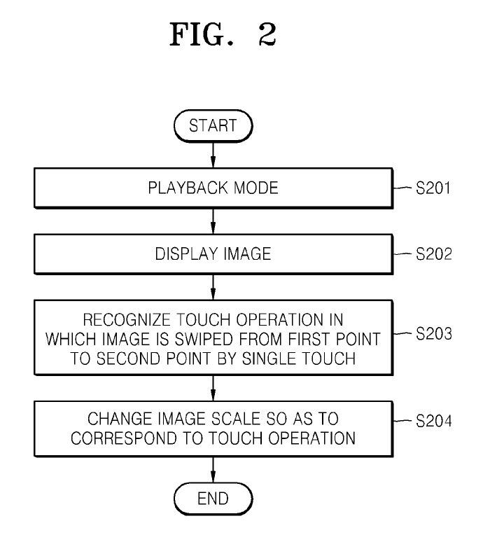

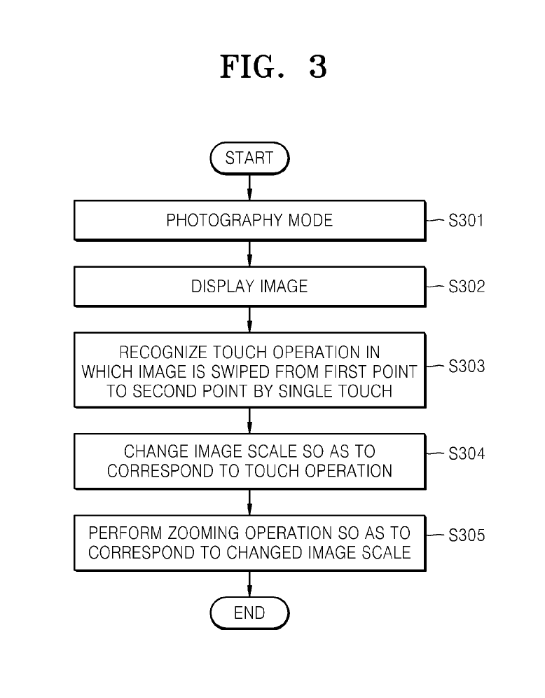

Each of the components of the digital camera 1000 will be described in detail together with methods of controlling the digital camera 1000, with reference to FIGS. 2 and 3.

FIGS. 2 and 3 are flowcharts of methods of controlling the digital camera 1000, according to embodiments of the present invention.

Hereinafter, the method of controlling the digital camera 1000 will be described with reference to FIG. 2.

In a playback mode (Operation S201) of the digital camera 1000, an image is displayed on the display unit 50 (Operation S202).

According to an embodiment of the present invention, the display unit 50 may be the touchscreen 51. In addition, according to an embodiment of the present invention, operation S201 may be a playback mode for playback of an image that has been already captured by the digital camera 1000. In this case, the image may be stored in the recording unit 40.

Then, the touch recognition unit 101 recognizes a touch operation in which the image is swiped from a first point to a second point on the touchscreen 51 (Operation S203).

According to the present embodiment, the touchscreen 51 is touched by a finger; however, an aspect of the present invention is not limited thereto, and the touchscreen 51 may be touched by a stylus.

The first point is a point at which the finger initially touches the image displayed on the touchscreen 51. The second point is a point at which the finger lastly touches the image displayed on the touchscreen after the finger moves without being removed from the image. In this case, a user performs a single touch in order to swipe the image from the first point to the second point. That is, the finger is not removed from the touchscreen 51 until the finger moves to the second point after touching the first point.

According to the present embodiment, since the digital camera 1000 is controlled through the single touch operation, the same result may be obtained by an easier manipulation than in a case where the digital camera 1000 is controlled by a plurality of touch operations. In addition, since a plurality of touch operations are not simultaneously required in order to control the digital camera 1000, it is easy to use a stylus, and thus touch errors may be reduced.

The touch recognition unit 101 recognizes the first point and the second point by using various methods that are well known. For example, the touch recognition unit 101 may recognize the first point and the second point as the respective coordinate values such as (X, Y), or may recognize the first point and the second point by dividing the touchscreen 51.

Then, the image scale adjusting unit 102 changes a scale of the image displayed on the touchscreen 51, and displays the image so as to correspond to the touch operation (Operation S204).

According to the present embodiment, the image scale adjusting unit 102 increases or decreases the image scale so as to correspond to a swiped length between the first point and the second point, and displays the image on the touchscreen 51.

In this case, a rate of increasing or decreasing the image scale may be determined using various methods. For example, the rate of increasing or decreasing the image scale may be determined according to a moving speed from the first point to the second point, in addition to according to the swiped length. In addition, the image scale may be determined according to a predetermined rate irrespective of the swiped length or the moving speed.

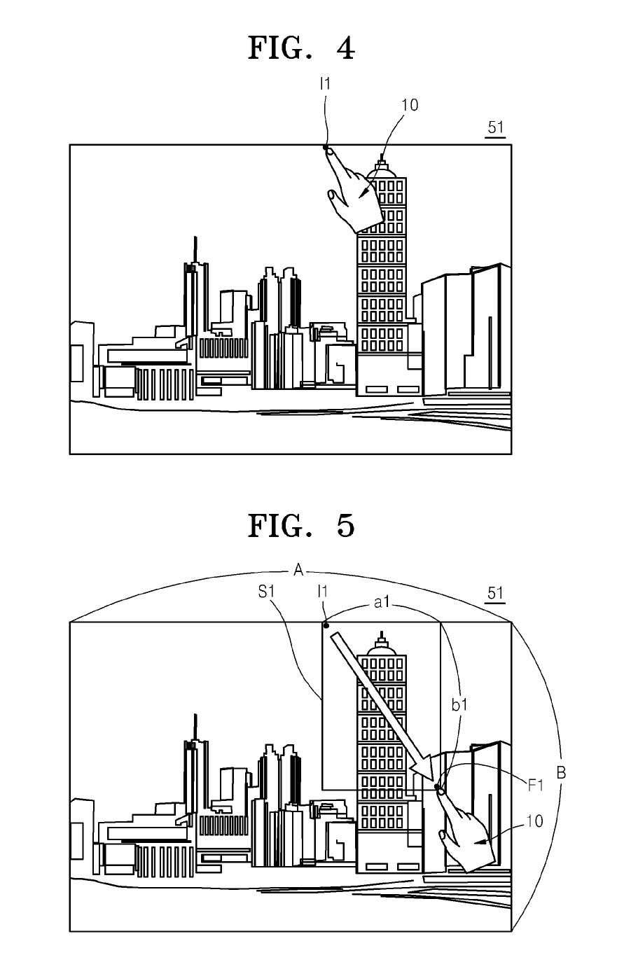

An operation for increasing or decreasing the image scale according to the touch operation will be described with reference to FIGS. 4 through 9, in more detail.

According to an embodiment of the invention, the adjusting of the image scale and the displaying of the image may be simultaneously performed together with the touch operation in which the image is swiped from the first point to the second point on the touchscreen 51. That is, while the user is moving the finger from the first point to the second point, the image that is being increased or decreased may be displayed on the touchscreen 51.

Throughout these operations, the user may visually check the touch operation and change the image scale. The user may stop the touch operation at a point of time when the user checks that the change in the image scale is completed to a desired degree. Thus, the user may accurately control the change in the image scale by the touch operation.

Hereinafter, a method of controlling the digital camera 1000 of FIG. 1, according to another embodiment of the present invention, will be described with reference to FIG. 3.

The method of FIG. 3 is different from the method of FIG. 2 in that the method according to the present embodiment is performed in a photography mode. In addition, according to the present embodiment, a zooming operation is performed so as to correspond to an image scale changed according to a touch operation. The remaining operations are the same as or similar to those of FIG. 2, and thus their descriptions are omitted.

In a photography mode of the digital camera 1000 (Operation S301), an image is displayed on the display unit 50 (Operation S302).

According to an embodiment of the invention, operation S301 may be a photography mode for displaying a live view of a subject in order for the digital camera 1000 to photograph the subject. In this case, an optical signal is input to the optical unit 11 from the subject, and an input image is transmitted through the imaging device 13, the analog signal processor 15 and the DSP 20 so as to be displayed on the touchscreen 51.

Then, the touch recognition unit 101 recognizes a user's touch operation in which the image is swiped from a first point to a second point on the touchscreen 51 (Operation S303)

Then, the image scale adjusting unit 102 changes a scale of an image displayed on the touchscreen 51, and displays an image so as to correspond to the touch operation (Operation S304).

The driver controller 103 performs the zooming operation so as to correspond to the change image scale (Operation S305).

The digital camera 1000 may previously determine a corresponding relationship between the changed image scale and a degree of operating a digital or optical zooming operation, and may store the relationship in the program storage unit 60. For example, a telephoto zooming operation may be performed by stages according to a rate of increasing the image scale. In this case, when it is assumed that a first telephoto zooming operation is performed whenever the image scale is increased by 20%, a second telephoto zooming operation may be performed when the image scale is increased to 140%. However, the corresponding relationship between the changed image scale and the degree of operating the digital or optical zooming operation is not limited thereto.

Conventionally, although a viewing angle increases as the number of zooming operations is increased, it is difficult to set a desired viewing angle. However, according to the present embodiment, since a user changes and sets a scale of an image displayed on a touchscreen, and then a zooming operation is automatically performed, this conventional problem may be resolved. Thus, the viewing angle is adjusted on the touchscreen rather than being adjusted through various zooming operations, and then the zooming operation may be automatically performed, thereby accurately controlling a zooming degree.

FIGS. 4 to 9 are images for explaining a method of controlling the digital camera 1000, according to an embodiment of the present invention.

FIGS. 4 to 6 show an operation of increasing an image scale so as to correspond to a touch operation. FIGS. 7 to 9 show an operation of decreasing the image scale so as to correspond to the touch operation.

First, the operation of increasing the image scale so as to correspond to the touch operation will be described with reference to FIGS. 4 to 6.

Referring to FIG. 4, a contact element 10 touches a first point 11 of an image displayed on the touchscreen 51.

Referring to FIG. 5, the contact element 10 diagonally swipes the image from the first point 11 to a second point F1 without being removed from the image. The first point 11 may be positioned above the second point F1, but an aspect of the present invention is not limited thereto. That is, the first point 11 has a smaller coordinate value than that of the second point F1 on a coordinates system of the touchscreen 51, or the first point 11 has a divisional number preceding a divisional number of the second point F1 on divisions of the touchscreen 51′. This may be performed with a singular contact element 10.

The image scale is increased to correspond to a swiped length between the first point 11 and the second point F1. A rectangle 51 having a diagonal line between the first point 11 and the second point F1 is generated using the first point 11 and the second point F1. Referring to FIG. 5, it is assumed that the rectangle 51 has a width al and a height b1. In addition, it is assumed that a width of the touchscreen 51 is A and a height of the touchscreen 51 is B. In this case, the image scale is increased until a longer side of the width and the height of the rectangle S1 is identical to the width or the height of the touch screen 51. When the height of the rectangle S1 is longer than the width of the rectangle S1, the image scale is increased until the height of the rectangle S1 is identical to the height of the touchscreen 51. Also, when the width of the rectangle S1 is longer than the height of the rectangle S1, the image scale is increased until the width of the rectangle S1 is identical to the width of the touchscreen 51. This is because the image scale is just increased while the image does not rotate on the touchscreen 51.

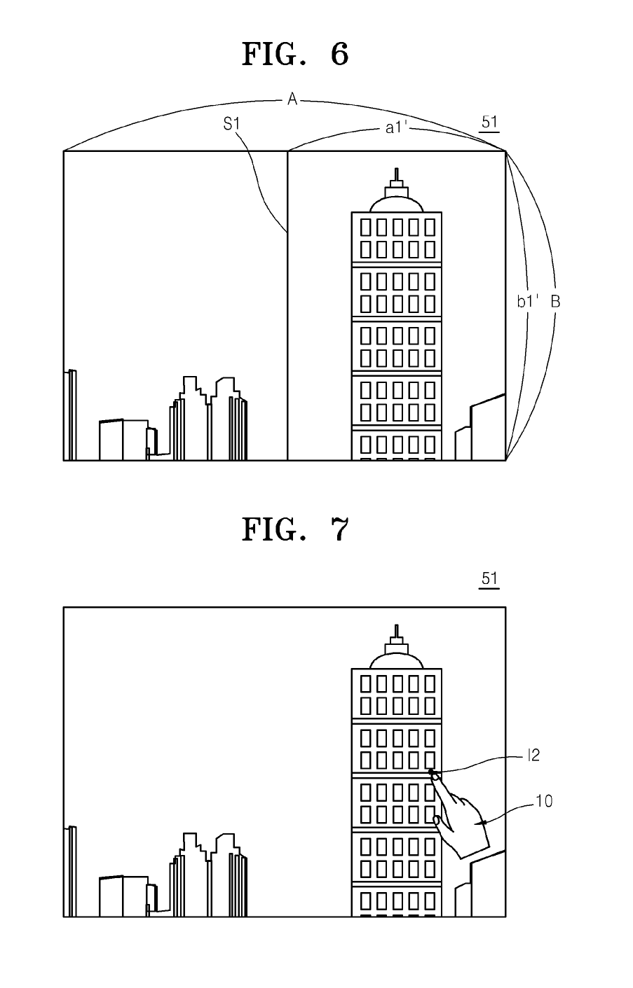

Referring to FIG. 6, since a height b1 of the rectangle S1 is longer than a width al of the rectangle S1 as shown in FIG. 5, the image scale is increased until the height b1 of the rectangle S1 is identical to the height B of the touchscreen 51. Thus, it can be seen that a height of the rectangle S1 is changed from b1 to b1′, and a width of the rectangle S1 is changed from a1 to a1′.

According to the present embodiment, the image may be increased by a predetermined area by a single touch operation such as a swipe performed on the touchscreen 51. Thus, a user may view a desired portion of the image in a desired magnification ratio.

For example, it is assumed that a first telephoto zooming operation is performed when a viewing angle (image scale) is increased by 1 cm on the touchscreen 51. A rectangle generated by diagonally swiping the image may have a width and a height of 2 cm×2 cm. In addition, a touchscreen of a digital camera may have a width and a height of 6 cm×4 cm. In this case, the height of the rectangle may be increased until the height is increased to 4 cm. That is, since a side of the rectangle is increased by 2 cm, a second telephoto zooming operation is performed.

Next, the operation of decreasing the image scale so as to correspond to the touch operation will be described with reference to FIGS. 7 to 9.

Referring to FIG. 7, the contact element 10 touches a first point 12 of an image displayed on the touchscreen 51. In this case, the operation of decreasing the image scale may be performed after the operation of increasing the image scale of FIGS. 4 to 6 is performed.

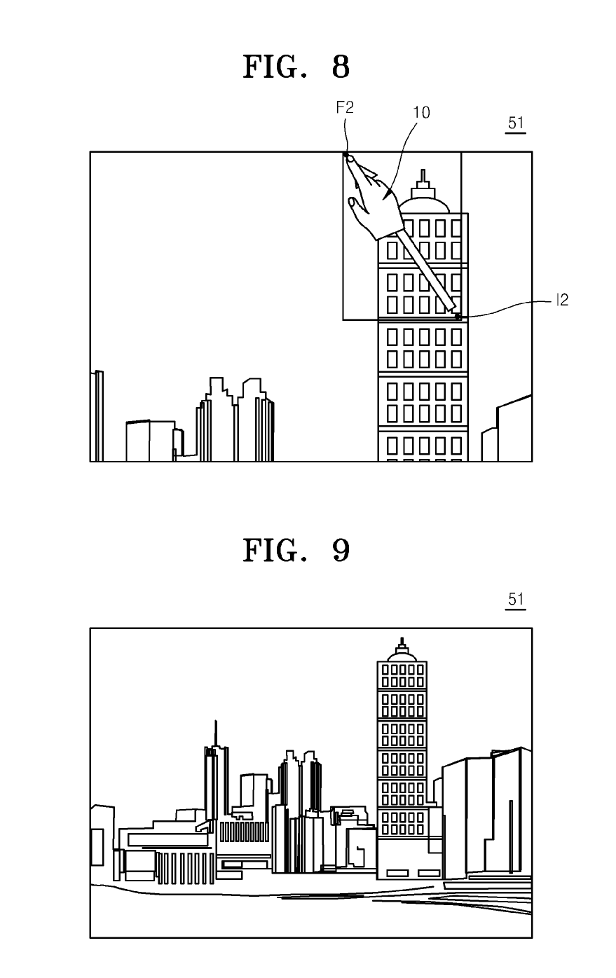

Referring to FIG. 8, the contact element 10 diagonally swipes the image from the first point 12 to a second F2 without being removed from the image. The first point 12 may be positioned below the second point F2, but an aspect of the present invention is not limited thereto. That is, the first point 12 has a greater coordinate value than that of the second point F2 on a coordinates system of the touchscreen 51, or the first point 12 has a divisional number following a divisional number of the second point F2 on divisions of the touchscreen 51.

The image scale is decreased to correspond to a swiped length between the first point 11 and the second point F1. In detail, a rate of decreasing the image may be determined based on a swiped length for increasing the image, that is, a length between the first point 11 and the second point F1 and a swiped length for decreasing the image, that is, a length between the first point 12 and the second point F2. For example, if the swiped length for decreasing the image, that is, the length between the first point 12 and the second point F2 is half of the swiped length for increasing the image, that is, a length between the first point 11 and the second point F1, the image scale is decreased in half of a magnification ratio.

Referring to FIG. 8, the image is swiped by the length between the first point 12 and the second point F2 of FIG. 7 in an opposite direction to that of the case of

FIGS. 4 to 6. Thus, referring to FIG. 9, it can be seen that the image scale is changed to the original image scale of FIG. 4.

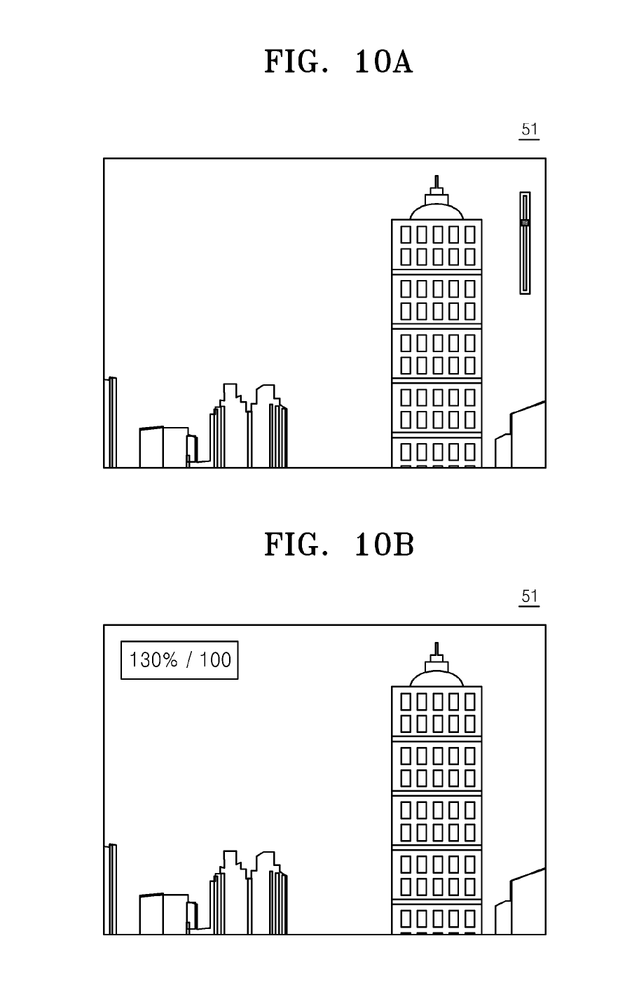

FIGS. 10A and 10B are diagrams for showing a degree of increasing or decreasing the image scale by using the method of controlling the digital camera 1000, according to an embodiment of the invention.

According to another embodiment, a degree of increasing or decreasing the image scale may be simultaneously displayed on the touchscreen 51 when the increased or decreased image scale is displayed on the touchscreen. In detail, as illustrated in FIG. 10A, the degree of increasing or decreasing the image scale may be displayed by a bar or a graph. In addition, as illustrated in FIG. 10B, the degree of increasing or decreasing the image scale may be numerically displayed by a percentage or a fractional number.

Thus, the user may visually and quickly check the degree of increasing or decreasing the image scale.

In summary, an aspect of the present invention may have the following advantages.

In conventional various methods of increasing an image scale, since an image is increased with respect to a central portion of a screen, a user cannot increase the image with respect to a desired point. Conventionally, when a user wants to increase a desired area of the image, a plurality of operations such as manipulations of directional keys or a touchscreen are required. However, a desired area of an image may be increased by a single touch operation performed on a touchscreen, and thus the image may be increased in size by a reduced number of manipulating operations.

In addition, the viewing angle is adjusted on the touchscreen rather than being adjusted through various zooming operations, and then the zooming operation may be automatically performed, thereby accurately controlling a zooming degree.

The invention can also be embodied as computer readable codes on a computer readable recording medium. The computer readable recording medium is any data storage device that can store data which can be thereafter read by a computer system.

The device described herein may comprise a processor, a memory for storing program data and executing it, a permanent storage such as a disk drive, a communications port for handling communications with external devices, and user interface devices, including a display, keys, etc. When software modules are involved, these software modules may be stored as program instructions or computer readable codes executable on the processor, on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

Accordingly, a desired area of an image may be increased by a single touch operation performed on a touchscreen, and thus the image may be increased in size by a reduced number of manipulating operations.

In addition, since this touch operation and an operation of increasing the image in terms of size are simultaneously performed, a user may check the operation of increasing the size of the image in real time, and thus a desired degree of increasing the size of the image may be accurately obtained.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a digital photographing apparatus comprising a touchscreen, the method comprising:
displaying an image on the touchscreen;
recognizing a touch operation in which the image is swiped from a first point to a second point on the touchscreen; and
changing an image scale so as to correspond to the recognized touch operation and displaying the image.

2. The method of claim 1, wherein the method is performed in a photography mode, and
wherein a zooming operation is performed so as to correspond to the changed image scale.

3. The method of claim 1, wherein the touch operation in which the image is swiped from the first point to the second point is performed by a single touch operation.

4. The method of claim 1, wherein the changing of the image scale is simultaneously performed together with the touch operation in which the image is swiped from the first point to the second point on the touchscreen.

5. The method of claim 1, wherein the changing of the image scale comprises increasing or decreasing of the image scale so as to correspond to a swiped length from the first point to the second point, and displaying the image.

6. The method of claim 5, wherein the increasing of the image scale is performed when the first point is positioned above the second point.

7. The method of claim 5, wherein the decreasing of the image scale is performed when the first point is positioned below the second point.

8. The method of claim 5, wherein a degree of increasing or decreasing the image scale is simultaneously displayed on the touchscreen when the image scale is increased or decreased and the image is displayed.

9. A non-transitory computer program product, comprising a computer usable medium having a computer readable program code embodied therein, said computer readable program code adapted to be executed to implement the method according to claim 1.

10. A digital photographing apparatus comprising:
a touchscreen;
a touch recognition unit for recognizing a touch operation in which the image is swiped from a first point to a second point on the touchscreen; and
an image scale adjusting unit for changing an image scale so as to correspond to the recognized touch operation and displaying the image.

11. The digital photographing apparatus of claim 10, further comprising a zoom controller for operating a zooming operation so as to correspond to the image scale changed in a photography mode.

12. The digital photographing apparatus of claim 10, wherein the touch operation in which the image is swiped from the first point to the second point is performed by a single touch operation.

13. The digital photographing apparatus of claim 10, wherein the image scale adjusting unit adjusts the image scale simultaneously with the touch operation in which the image is swiped from the first point to the second point on the touchscreen.

14. The digital photographing apparatus of claim 10, wherein the image scale adjusting unit increases or decreases the image scale so as to correspond to a swiped length from the first point to the second point, and displays the image.

15. The digital photographing apparatus of claim 10, wherein the image scale adjusting unit displays a degree of increasing or decreasing the image scale on the touchscreen simultaneously when the image scale is increased or decreased and the image is displayed.
